(19) United States
(12) Patent Application Publication
(10) Pub. No.: US 2022/0379395 A1
(43) Pub. Date: Dec. 1, 2022

(54) METHOD FOR MACHINING AND MEASURING WORKPIECES

(71) Applicant: Klingelnberg GmbH, Huckeswagen (DE)

(72) Inventor: Karl-Martin RIBBECK, Remscheid (DE)

(21) Appl. No.: 17/824,272

(22) Filed: May 25, 2022

(30) Foreign Application Priority Data
May 25, 2021 (EP) 21175836

(51) Int. Cl. B23F 23/12; B23F 1/02; B23F 23/10; B23F 9/02; B23F 9/08; B23F 1/06

(52) U.S. Cl. CPC B23F 23/1218; B23F 1/023; B23F 23/10; B23F 9/02; B23F 9/08; B23F 1/06

(57) ABSTRACT

A method for machining and measuring workpieces includes: machining a workpiece by a gear cutting process, wherein a tooth flank of the workpiece is produced or machined; measuring an actual geometry of the tooth flank produced by the gear cutting process by a measuring process; determining a deviation of the actual geometry from a predetermined nominal geometry of the tooth flank; determining a corrected gear cutting process for at least partially reducing the deviation; and machining the workpiece and/or a further workpiece by the corrected gear cutting process. The determination of the corrected gear cutting process for at least partial reduction of the deviation has the specification that a distinction is made between first and second evaluation areas of the tooth flank, wherein first and second permissible deviations of the actual geometry from the nominal geometry is specified for the evaluation areas of the tooth flank, respectively.

### CROSS-REFERENCE TO RELATED APPLICATIONS

This application is related to and claims the benefit of European Patent Application No. 21175836, filed on May 25, 2021, the contents of which are herein incorporated by reference in their entirety.

### TECHNICAL FIELD

The present disclosure relates to methods for machining and measuring workpieces. Workpieces which have one or more tooth flanks and which are manufactured or machined by gear cutting processes are, for example, gearwheels of toothed gearings. Such toothed gearings transmit and translate speeds and torques between rotating shafts during operation and are used, for example, in motor vehicle transmissions, in industrial transmissions, in aviation or in maritime applications.

### BACKGROUND

The demands on the accuracy or quality of such toothed gearings have continued to increase in recent years, for example due to the trend towards electromobility. For example, there is a constant demand to reliably transmit ever higher torques and speeds with compact and lightweight toothed gearings. In electric vehicles, recuperation during braking exposes the toothed gearings to load profiles that have not previously been encountered in vehicles driven purely by internal combustion engines. Furthermore, the transmission of torques and speeds should be as quiet as possible, since transmission noise in electric vehicles is no longer masked by the noise of an internal combustion engine and can be perceived as annoying by the vehicle occupants.

The quality of toothings in industrial production is often ensured by so-called closed-loop processes. In this process, a toothing is manufactured on a gear cutting machine and then measured in a coordinate measuring machine for gear measurement in order to check compliance with specified tolerances. To determine deviations of a measured actual geometry of the toothing from a specified nominal geometry, the deviations are usually measured on a few teeth or on all teeth of the toothing and average values of the deviations are formed. This is because it can be assumed that the correctable, systematic deviations are similar for all teeth of the toothing.

If the average deviations are not within the specified range or if a trend towards exceeding a tolerance can be detected, the machine kinematics and/or the tool geometry of the gear cutting process are adjusted on the basis of the measurement results so that a closed quality control loop is formed.

Deviations of a measured actual geometry of a tooth flank from a specified nominal geometry or the average deviations are corrected in such a way that these deviations are minimized overall. No distinction is made as to which area of the tooth flank is affected by the deviation. It is therefore possible that a deviation in a heavily loaded area of the tooth flank is corrected within the intended tolerance, but the full correction potential for this heavily loaded area is not utilized, since deviations of the tooth flank in areas not heavily loaded and non-load-bearing areas of the tooth flank are also corrected at the same time. Since all areas of the tooth flank are treated equally during the correction, the result of the correction may be an unfavorable compromise at the expense of the heavily loaded area.

### SUMMARY

Against this background, the disclosure is based on the technical problem of providing improved methods which, for example, enable improved evaluation and/or correction of deviations of tooth flanks in particular. The technical problem described above is solved in each case by the independent claims. Further embodiments of the disclosure result from the dependent claims and the following description.

According to a first aspect, the disclosure relates to a method comprising the method steps of: Machining a workpiece by means of a gear cutting process, wherein a tooth flank of the workpiece is produced or machined; Measuring an actual geometry of the tooth flank of the workpiece produced by means of the gear cutting process by means of a measuring process; Determining a deviation of the actual geometry of the tooth flank from a predetermined nominal geometry of the tooth flank; Determining a corrected gear cutting process for at least partially reducing the deviation; Machining the workpiece and/or a further workpiece by means of the corrected gear cutting process. The method is characterized in that the determination of the corrected gear cutting process for at least partial reduction of the deviation has the specification that a distinction is made between a first evaluation area of the tooth flank and a second evaluation area of the tooth flank, wherein a first permissible deviation of the actual geometry from the nominal geometry is specified for the first evaluation area of the tooth flank, a second permissible deviation of the actual geometry from the nominal geometry is specified for a second evaluation area of the tooth flank, and the first permissible deviation is smaller than the second permissible deviation. Alternatively or additionally, for mathematical optimization for at least partial reduction of the deviation, a first weighting is specified for a deviation of the first evaluation area of the tooth flank and a second weighting is specified for a deviation of the second evaluation area of the tooth flank, wherein the first weighting is greater than the second weighting.

The method according to the disclosure makes it possible to prioritize certain deviations and areas of the tooth flank and to correct them in a more targeted manner by distinguishing evaluation areas of the tooth flank.

For example, very narrow tolerances can be specified for the center of the tooth flank, but these are not required e.g. in the area of any end reliefs of the tooth flank, since the tooth flank in the area of end reliefs does not come into contact with an associated mating flank during operation. Furthermore, a deviation, e.g. for the center of the tooth flank, can have a higher weighting than a deviation in the area of the end reliefs, so that this deviation in the area of the center of the tooth flank is taken into account to a greater extent in the course of the mathematical optimization.

Consequently, it can be achieved that e.g. deviations in marginal areas do not restrict or limit the correction of deviations in areas to be prioritized or their influence on the correction is at least reduced. In other words, the deviations can be prioritized and weighted depending on their position on the tooth flank in order to improve the overall correction result and optimize it against the background of the expected operating loads. It may be provided that the determination of the corrected gear cutting process is carried out by means of a nonlinear optimization.

The mathematical optimization can be a multi-criteria optimization, wherein the deviations of the first evaluation area are assigned a higher weighting than the deviations of the second evaluation area.

The measuring process can be carried out by means of a coordinate measuring machine. The coordinate measuring machine can have an optical measuring device for optical toothing measurement. The coordinate measuring machine can alternatively or additionally have a tactile measuring device for tactile toothing measurement.

The measuring process can be carried out by means of a machine tool that is set up both for measuring and for machining the workpiece. The machine tool can have an optical measuring device for optical toothing measurement. The machine tool can alternatively or additionally have a tactile measuring device for tactile toothing measurement.

The nominal geometry of the workpiece may have been generated as a dataset by a computer-aided design of the workpiece.

The nominal geometry can be, for example, a function-oriented nominal geometry or a process-oriented nominal geometry. The function-oriented nominal geometry represents the geometry of the workpiece defined with regard to functional properties, which, however, may not be achievable in practice due to limits of the producible tool geometry and/or the machine kinematics. An example is an involute helical spur gear with a pure width crowning as modification. If this spur gear is ground in a conventional generating grinding process with an unmodified grinding worm, a so-called natural interleaving always occurs in addition to the width crowning.

The process-oriented nominal geometry is the geometry of the toothing that is created in a gear cutting process taking into account a deviation-free tool geometry and deviation-free machine kinematics. For example, the nominal geometry used in industrial practice for measuring spiral bevel gears is a process-oriented nominal geometry.

The actual geometry of the tooth flank of the workpiece is the geometry created on the workpiece by means of the gear cutting process.

The workpiece may be a gearwheel of a toothed gearing, such as a spur gear, a bevel gear, or the like, wherein a plurality of tooth flanks of the gearwheel may be machined or produced when the gearwheel is machined by the gear cutting process.

The gear cutting process may have one or more machining steps.

A machining step of the gear cutting process may comprise machining the workpiece with a tool having a geometrically defined cutting edge. Machining of the workpiece with the tool with geometrically defined cutting edge may be, for example, gear hobbing, profile milling, gear deburring, hob peeling, bevel gear milling or the like.

A machining step of the gear cutting process may include machining the workpiece with a tool having a geometrically undefined cutting edge. The machining of the workpiece with the tool with geometrically undefined cutting edge can be, for example, grinding, lapping or honing.

It may be provided that one of the aforementioned machining steps of the gear cutting process is carried out as pre-cutting in the soft state of the workpiece, i.e. as soft machining.

It may be provided that one of the aforementioned machining steps of the gear cutting process is carried out in the hard state of the workpiece, i.e. as a hard machining operation after the workpiece has been hardened.

Determining a corrected gear cutting process to at least partially reduce the deviation may involve one processing step or multiple processing steps. In particular, the determination of the corrected gear cutting process can have one correction step or several correction steps. For example, it can be provided that a correction step can be assigned to each machining step.

For example, if gear hobbing of a workpiece in the soft state is performed first, a gear hobbing correction step can be performed after gear hobbing to reduce the deviations of the machining step of “gear hobbing”. Subsequently, after hardening of the workpiece, hard machining of the workpiece can be performed by generating grinding, wherein a correction step of generating grinding is performed after generating grinding to reduce the deviations of the machining step of “generating grinding”.

Both the gear hobbing correction step and the generating grinding correction step can be carried out in such a way that the determination of the corrected machining step for at least partial reduction of the deviation for the respective machining step has the specifications that a first permissible deviation of the actual geometry from the nominal geometry is specified for a first evaluation area of the tooth flank, that a second permissible deviation of the actual geometry from the nominal geometry is specified for a second evaluation area of the tooth flank, and that the first permissible deviation is smaller than the second permissible deviation.

Each machining step of the gear cutting process can therefore be assigned a machining-step-specific correction step. The same evaluation areas of the tooth flank can be specified for the machining steps or different evaluation areas of the tooth flank can be specified. Alternatively or additionally, the same permissible deviations for the evaluation areas of the tooth flank can be specified for the machining steps, or deviating permissible deviations for the evaluation areas of the tooth flank can be specified.

For example, for the aforementioned “gear hobbing” machining step, which can exemplarily represent a first machining step of the gear cutting process, a first evaluation area of the tooth flank can be specified, which is different from a first evaluation area of the tooth flank of the aforementioned “gear grinding” machining step, which can exemplarily represent a second machining step of the gear cutting process.

For example, for the aforementioned “gear hobbing” machining step, which can exemplarily represent a first machining step of the gear cutting process, a second evaluation area of the tooth flank can be specified, which is different from a second evaluation area of the tooth flank of the aforementioned “generating grinding” machining step, which can exemplarily represent a second machining step of the gear cutting process.

Alternatively, the first and second evaluation areas of the “gear hobbing” and “generating grinding” machining steps can be identical.

This applies equally to the permissible deviations assigned to the respective evaluation areas, so that the permissible deviations assigned to first evaluation areas of the processing steps can be identical to or different from each other, and that the permissible deviations assigned to second evaluation areas of the processing steps can be identical to or different from each other.

It can be provided that the first evaluation area has one or more sections of the tooth flank, which can be arranged contiguously or at least partially spaced apart from each other. The sections of the first evaluation area can therefore be distributed over the tooth flank at a distance and/or be directly adjacent to one another.

Each section of the first evaluation area can be assigned a permissible section deviation that lies within the permissible deviation of the first evaluation area and differs from a further permissible section deviation of a further section of the first evaluation area. Accordingly, further gradations or weightings can be made within the first evaluation area in order to prioritize certain sections within the first evaluation area.

It can be provided that the second evaluation area has one or more sections of the tooth flank, which can be arranged contiguously or at least sectionally spaced apart from each other. The sections of the second evaluation area can therefore be distributed over the tooth flank at a distance from one another and/or be directly adjacent to one another.

Each section of the second evaluation area can be assigned a permissible section deviation that lies within the permissible deviation of the second evaluation area and differs from a further permissible section deviation of a further section of the second evaluation area. Accordingly, further gradations or weightings can be made within the second evaluation area in order to prioritize certain sections within the second evaluation area.

It may be provided that three or more evaluation areas are specified. Each of these three or more evaluation areas can have one or more sections of the tooth flank.

The evaluation areas are used to prioritize heavily stressed or loaded flank areas of the tooth flank, e.g. to enable tighter tolerances in these prioritized areas. Alternatively or additionally, areas of the tooth flanks can be prioritized that are critical for noise excitation in tooth meshing.

The first evaluation area can be assigned a tooth flank load-bearing area that is at a distance from the ends or edges of the tooth flank. Alternatively or additionally, the second evaluation area can be assigned an edge area that has ends or edges of the tooth flank or is adjacent to them.

In particular, the load-bearing area of the tooth flank comprises all those sections of the tooth flank that come into contact with an associated mating flank during operation and roll off in order to transmit and translate torques and speeds, i.e. in particular all contact lines or contact points. In particular, the load-bearing area alternatively or additionally includes all those sections of the tooth flank that exceed a predetermined load threshold or a predetermined load criterion during operation.

The edge area of the tooth flank comprises in particular all those sections of the tooth flank that do not come into contact with an associated mating flank during operation. In particular, the edge area alternatively or additionally includes all those sections of the tooth flank that fall below a predefined load threshold or a predefined load criterion during operation.

The assignment of a section of the tooth flank to the first evaluation area or to the second evaluation area can take place depending on whether a contact of the respective section to a mating flank takes place during operation. Alternatively or additionally, the assignment of a section of the tooth flank to the first evaluation area or to the second evaluation area can take place depending on whether a predetermined load threshold or a predetermined load criterion is undershot or exceeded.

When reference is made to a load threshold in this context, it is, for example, a predefined limit value for the Hertzian pressure occurring during operation. For example, it can be provided that one or more sections of the tooth flank, for which the exceeding of a predetermined Hertzian pressure is to be expected in operation, are assigned to the first evaluation area and that one or more sections of the tooth flank, for which no exceeding of a predetermined Hertzian pressure is to be expected in operation, are assigned to the second evaluation area.

When reference is made to a load criterion in this context, it is, for example, a predefined limit value that takes into account at least two influencing variables that have an effect on the load capacity, such as the Hertzian pressure and the slip. For example, it can be provided that one or more sections of the tooth flank, for which the exceeding of a predetermined Hertzian pressure and a predetermined slip is to be expected in operation, are assigned to the first evaluation area and that one or more sections of the tooth flank, for which no exceeding of a predetermined Hertzian pressure and a predetermined slip is to be expected in operation, are assigned to the second evaluation area.

When reference is made in this context to a permissible deviation of the actual geometry from the nominal geometry, the permissible deviation can be tolerances to be observed for one or more of the toothing deviations and toothing modifications listed below, which can also be referred to as parameters or quality characteristics of a toothing:
Profile deviations, such as the total profile deviation, the profile shape deviation, the profile angle deviation, the pressure angle deviation or the like, and/or the deviations of one or more tooth flank modifications in the profile direction, such as deviations of the vertical crowning, the tip and/or root relief, the profile angle modification, the profile interleaving or the like;
Flank line deviations, such as the flank line total deviation, the flank line shape deviation, the flank line angle deviation, the spiral angle deviation or the like and/or the deviations of one or more tooth flank modifications in flank direction, such as deviations of width crowning, end reliefs, flank line angle modification, flank line interleaving or the like.

When reference is made in this context to a permissible deviation of the actual geometry from the nominal geometry, this may not only concern a single tooth flank or a single tooth on its own, but two or more tooth flanks or teeth of the workpiece, which are evaluated according to the aforementioned deviations. In particular, corrections can be made against mean deviations formed from the deviations of the actual geometry from the nominal geometry for two or more tooth flanks.

Alternatively or in addition, the permissible deviation tolerances to be maintained for two or more teeth or tooth flanks of the workpiece may have one or more of the gear tooth deviations listed below:
Pitch deviations, such as the pitch single deviation, the pitch sum deviation, the pitch jump or the like;
Tooth thickness deviations;
Concentricity deviations
Roundness deviations;
Runout deviations;
Flatness deviations;
Warping/interleaving.

It can be provided that the first permissible deviation of the actual geometry from the nominal geometry for a respective measuring point or a section of the first evaluation area is selected from a range smaller than or equal to 10 μm, in particular selected from a range smaller than or equal to 5 μm, and the second permissible deviation of the actual geometry from the nominal geometry for a respective measuring point or a section of the second evaluation area is selected from a range smaller than or equal to 15 μm, in particular selected from a range smaller than or equal to 10 μm. Absolute amounts can therefore be specified for the respective permissible deviations.

For example, it can be provided that determining a corrected gear cutting process may comprise reducing the individual deviations of the measurement points for at least one of the evaluation areas below a predetermined threshold value, wherein the threshold value is, for example, 10 μm or less, in particular 5 μm or less.

For example, it can be provided that determining a corrected gear cutting process for at least one of the evaluation areas may involve minimizing the sum of the squares of the errors.

For example, it can be provided that determining a corrected gear cutting process for at least one of the evaluation areas comprises optimizing parameters or quality characteristics calculated from the deviations, such as minimizing a spiral angle deviation of a bevel gear. It can be provided, for example, that for the first evaluation area of the tooth flank or the respective first evaluation area of several tooth flanks the first permissible deviation is predetermined, wherein the first permissible deviation has first permissible tolerances for the vertical crowning, the profile angle deviation, the width crowning, the width crowning and the flank line angle deviation, and in that the second permissible deviation is predetermined for the second evaluation area of the tooth flank or the respective second evaluation area of a plurality of tooth flanks, wherein the second permissible deviation has second permissible tolerances for the vertical crowning, the profile angle deviation, the width crowning, the width crowning and the flank line angle deviation which differ partially or completely from the permissible tolerances of the first permissible deviation.

It can be provided that different parameters are used for the first evaluation area, so that, for example, for the first evaluation area of the tooth flank or the respective first evaluation area of several tooth flanks, the first permissible deviation is specified, which has permissible tolerances for the vertical crowning, the profile angular deviation, the width crowning and the flank line angular deviation, the width crowning and the flank line angular deviation, while the second permissible deviation is specified for the second evaluation area of the tooth flank or the respective second evaluation area of a plurality of tooth flanks, wherein the second permissible deviation has permissible tolerances for deviations from end reliefs, tip reliefs or root reliefs.

In this way, the parameters or quality characteristics of the toothing that are particularly relevant for the respective evaluation area can be taken into account and corrected.

As already explained, the actual geometry of one or more tooth flanks of the workpiece can be measured using optical and/or tactile measuring methods.

It can be provided that when measuring the actual geometry of the tooth flank of the workpiece generated by means of the gear cutting process, a measuring grid with measuring points is detected by means of the measuring process, in that, when determining the deviation of the actual geometry of the tooth flank from the predetermined nominal geometry of the tooth flank, a respective deviation of the actual position of the respective measuring point from the nominal position of the respective measuring point is determined for each measuring point of the measuring grid, and in that a first group of the measuring points is assigned to the first evaluation area, and in that a second group of the measuring points is assigned to the second evaluation area. Insofar as a third, fourth or nth evaluation area are provided, a third, fourth or nth group of the measuring points would accordingly be assigned to the respective third, fourth or nth evaluation area.

It can be provided that the evaluation areas do not overlap. In particular, a measuring point of the measured actual geometry that is assigned to a respective evaluation area is not assigned to any other evaluation area.

It can be provided that the evaluation areas overlap.

The evaluation areas can overlap in particular in such a way that one or more measuring points are assigned to one evaluation area and also to another evaluation area. If a weighting and/or tolerance is specified, the highest weighting and lowest tolerance assigned in each case have priority for a measuring point assigned to two or more evaluation areas.

In particular, the evaluation areas can overlap in such a way that none of the measuring points assigned to one evaluation area is assigned to another evaluation area. For example, one evaluation area can be spanned by a measuring grid with measuring points and another evaluation area can be defined by a contact path which, however, does not intersect any measuring point of the measuring grid.

It can be provided that grid lines of a measuring grid are scanned, wherein each grid line is scanned with a predetermined resolution. The measuring points can be determined from a measuring point cloud resulting from the scan data. Alternatively or additionally, it can be provided that individual measuring points of the grid are approached and measured individually.

It may be provided that a contact path is detected by scanning, wherein the contact path is scanned with a predetermined resolution.

It can be provided that the contact path is scanned with a higher resolution than grid lines of a measuring grid.

A measuring grid can be specified in rows and columns such that, for example, a measuring grid is defined by a number of rows i, wherein i is a natural number greater than 1, and a number of columns j, wherein j is a natural number greater than 1, and the rows and columns cross each other, in particular cross each other in a projection, for example, at an angle of approximately 90° (radial projection). In particular, crossing points and end points of the rows and columns define the measurement points of such a measuring grid.

As described above, the rows and columns of a measuring grid can be scanned, i.e. continuously scanned. If, for example, a tactile measuring probe is used, the probe scans each grid line, i.e. each of the rows and columns, in continuous engagement with the tooth flank, wherein measured values are recorded in a predefined resolution. For example, it can be provided that for each grid line more than 10 and less than 1000 measuring points are acquired during the scanning process, wherein the measuring points can be arranged in particular equidistantly distributed along the relevant grid line.

Individual measuring points or parameters or quality characteristics of the toothing or tooth flank can be derived from the measuring points of the scanned grid lines.

A measuring grid can be indented, i.e. have a distance to edges or borders of the tooth flank, so that the measuring result is not falsified by any burrs in the area of the edges or borders.

The first and second evaluation areas can be determined, for example, in such a way that an intersection is formed between the contact lines of a tooth flank and the measuring grid and, for example, all measuring points that intersect the contact lines or lie within a section of the tooth flank enveloping the contact lines are assigned to the first evaluation area, and all measuring points that do not intersect the contact lines or do not lie within a section of the tooth flank enveloping the contact lines are assigned to the second evaluation area.

The contact lines or a section of the tooth flank enveloping the contact lines can be determined by computer-aided simulations and/or bench tests.

According to one embodiment of the method, it is provided that after machining the workpiece and/or a further workpiece by means of the corrected gear cutting process, an actual deviation of a tooth flank machined by means of the corrected gear cutting process is smaller than the first permissible deviation for the first evaluation area and is smaller than the second permissible deviation for the second evaluation area.

According to one embodiment of the method, it is provided that two or more tooth flanks of the workpiece are produced or machined when the workpiece is machined by means of the gear cutting process, that when the actual geometry produced by means of the gear cutting process is measured, two or more tooth flanks of the workpiece are measured by means of the measuring method; in that, when determining deviations of the actual geometry of the respectively measured tooth flanks from the predetermined nominal geometry, a mean deviation is determined from the deviations of the respectively measured tooth flanks; and in that the determination of the corrected gear cutting process for at least partial reduction of the deviations is carried out on the basis of the mean deviation and applies to all tooth flanks.

In other words, to determine deviations of a measured actual geometry of the tooth flanks from a specified nominal geometry, the deviations are measured on a few teeth or on all teeth of the toothing and average values of the deviations are formed. This is because it can be assumed that the correctable, systematic deviations are similar for all tooth flanks of the workpiece. The tooth flanks are thus corrected on average, especially in continuous part processes. In the single part process, individual tooth flanks could be corrected individually.

The corrected gear cutting process can have modified kinematics compared to the gear cutting process. Alternatively or additionally, the corrected gear cutting process can have a modified tool geometry compared to the gear cutting process.

It can be provided that before determining the corrected gear cutting process, the possibility of changing the tool geometry is enabled or disabled and/or that before determining the corrected gear cutting process, the possibility of changing the kinematics is enabled or disabled. It is therefore possible to specify which degrees of freedom are available for the correction. For example, in the case of non-dressable tools, it is not possible to deviate from the shape of the tool or the changes to the tool shape would require too much time and cost. Therefore, in the case of non-dressable tools, such as a milling tool, the possibility of changing the tool geometry would be blocked and the possibility of changing the kinematics would be enabled, while, for example, in the case of a dressable grinding tool, the possibility of changing the tool geometry and also the kinematics could be enabled.

It can be provided that only certain parameters of the tool are available for the correction. For example, certain clearance angles can be blocked, which are required for collision-free production.

It can be provided that only certain parameters of the kinematics are available for the correction. For example, the tool speed, the feed rate and/or individual axes that generate the relative movement between the tool and the workpiece can be locked.

The workpiece is in particular a gearwheel of a toothed gearing, such as a spur gear, a bevel gear or the like, wherein a plurality of tooth flanks of the gearwheel are machined or produced during machining of the gearwheel by means of the gear cutting process.

According to a second aspect, the disclosure relates to a method comprising the steps of: Measuring an actual geometry of a tooth flank of a workpiece generated by means of a gear cutting process by means of a measuring process; Determining a deviation of the actual geometry of the tooth flank from a predetermined nominal geometry of the tooth flank; Evaluating the deviation; The method is characterized in that the evaluation of the deviation has the specification that a first permissible deviation of the actual geometry from the nominal geometry is specified for a first evaluation area of the tooth flank, in that a second permissible deviation of the actual geometry from the nominal geometry is specified for a second evaluation area of the tooth flank, and in that the first permissible deviation is smaller than the second permissible deviation.

It is therefore possible to prioritize or weight areas of the tooth flank by specifying tighter tolerances for the first evaluation area than for the second evaluation area.

The first evaluation area and the second evaluation area as well as the permissible deviations correspond to those evaluation areas and deviations which have already been described for the first aspect of the disclosure. All variants and embodiments of the evaluation areas and the permissible deviations that have been described for the first aspect of the disclosure therefore also apply to the second aspect of the disclosure and can be transferred in an identical manner to the second aspect of the disclosure.

In particular, it can be provided, for example, that the first evaluation area is assigned a load-bearing area tooth flank that is at a distance from ends or edges of the tooth flank and/or that the second evaluation area is assigned an edge area that has ends or edges of the tooth flank or is adjacent to them.

In particular, it can be provided, for example, that when measuring the actual geometry of the tooth flank of the workpiece generated by means of the gear cutting process, a measuring grid with measuring points is detected by means of the measuring method, that when determining the deviation of the actual geometry of the tooth flank from the specified nominal geometry of the tooth flank, a deviation of the actual position of the respective measuring point from the nominal position of the respective measuring point is determined for each measuring point of the measuring grid, and that a first group of the measuring points is assigned to the first evaluation area and that a second group of the measuring points is assigned to the second evaluation area.

### BRIEF DESCRIPTION OF THE DRAWINGS

The disclosure is described in more detail below with reference to drawings illustrating exemplary embodiments. They show schematically in each case:

FIG. 1 shows a flowchart of a method according to the first aspect of the disclosure;

FIG. 2 shows a workpiece in the form of a toothing blank;

FIG. 3 shows the workpiece from FIG. 2 during roughing;

FIG. 4 shows the workpiece from FIG. 3 after roughing;

FIG. 5 shows the workpiece from FIG. 4 with a measuring grid;

FIG. 6 shows a toothing measuring machine with the rough machined workpiece from FIG. 4;

FIG. 7 shows a tooth flank with a measuring grid;

FIG. 8 shows the tooth flank from FIG. 7 with measuring points of the measuring grid from FIG. 7;

FIG. 9 shows the tooth flank and the measuring points from FIG. 8 with evaluation areas;

FIG. 11 shows measuring points of a first evaluation area;

FIG. 12 shows measuring points of a second evaluation area;

FIG. 13 shows the tooth flank and the measuring points from FIG. 8 with further evaluation areas;

FIG. 14 shows measuring points of a first evaluation area according to FIG. 13;

FIG. 15 shows measuring points of a second evaluation area according to FIG. 13;

FIG. 16 shows the tooth flank and the measuring points from FIG. 8 with further evaluation areas;

FIG. 17 shows measuring points of a first evaluation area according to FIG. 16;

FIG. 18 shows measuring points of a second evaluation area according to FIG. 16;

FIG. 19 shows measuring points of a second evaluation area according to FIG. 16;

FIG. 20 shows the workpiece from FIG. 4 during hard machining;

FIG. 21 shows a production chain;

FIG. 22 shows a flow chart of a method according to the second aspect of the disclosure

FIG. 23 shows a bevel gear;

FIG. 24 shows an enlarged view of the bevel gear from FIG. 23;

FIG. 25 shows the tooth flank with a measuring grid and a contact path;

FIG. 26 shows measuring points of a first and second evaluation area;

FIG. 27 shows measuring points of the first evaluation area; and

FIG. 28 shows measuring points of the second evaluation area.

### DETAILED DESCRIPTION OF THE DRAWINGS

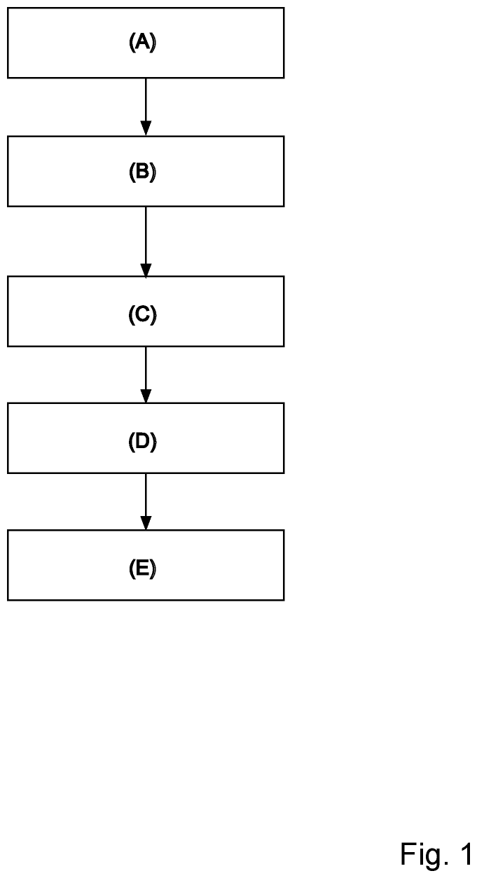

FIG. 1 shows a flowchart of a method according to the first aspect of the disclosure.

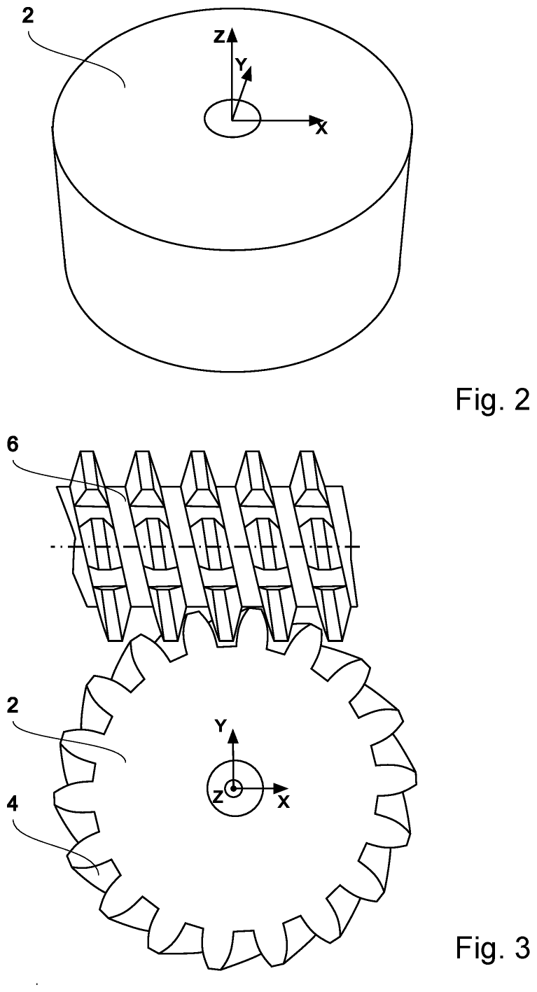

First, in method step (A), a workpiece 2 is machined by means of a gear cutting process, wherein tooth flanks 4 of the workpiece 2 are produced. For this purpose, the workpiece 2 is first provided as an untoothed blank 2, as shown in FIG. 2.

The blank 2 is machined by hobbing in the soft state, so that the blank 2 has not been hardened before hobbing. The gear cutting process therefore features the “gear hobbing” machining step, as shown schematically in FIG. 3 with the hobbing tool 6. Here, hobbing can also be referred to as soft machining or roughing. FIG. 4 shows the workpiece 2 after hobbing. The workpiece 2 according to FIG. 4 is a helical gear 2.

Subsequently, in a method step (B), an actual geometry of the tooth flanks 4 of the workpiece 2 generated by means of hobbing is measured by means of a measuring method.

For this purpose, a measuring grid 8 is defined, as shown in FIG. 5 as an example for one of the tooth flanks 4. The measuring grid 8 has a predetermined number of lines i and columns j. Each intersection point and each end point of the grid lines of the measuring grid 8 forms a measuring point 10, so that when determining the deviation of the actual geometry of the tooth flank 4 from the predetermined nominal geometry of the tooth flank 4, a respective deviation of the actual position of the respective measuring point 10 from the nominal position of the respective measuring point 10 is determined for each measuring point 10 of the measuring grid 8. The measuring points 10 can be determined by a single probing or by scanning the grid lines of the measuring grid 8.

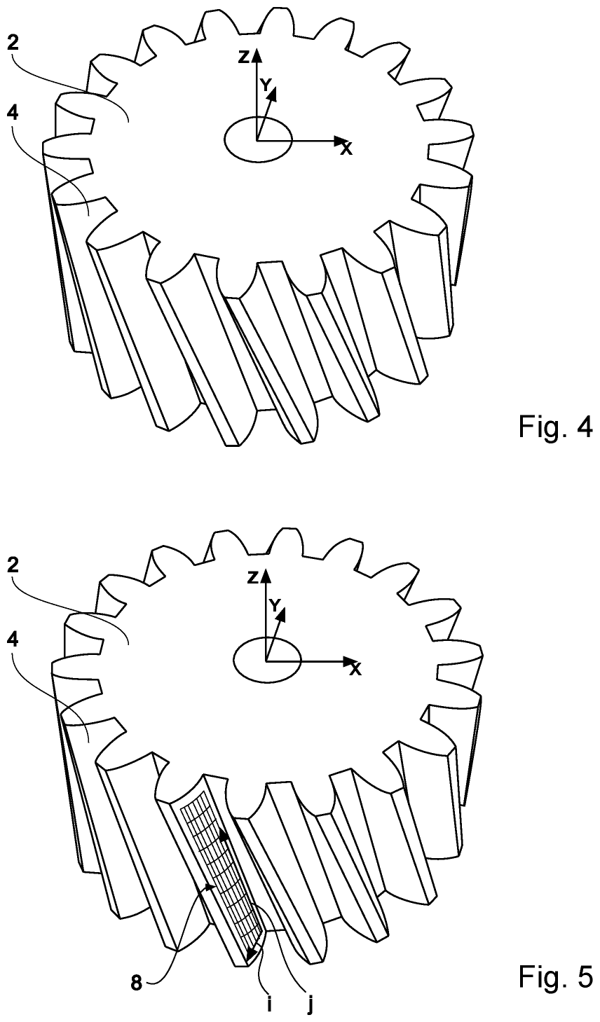

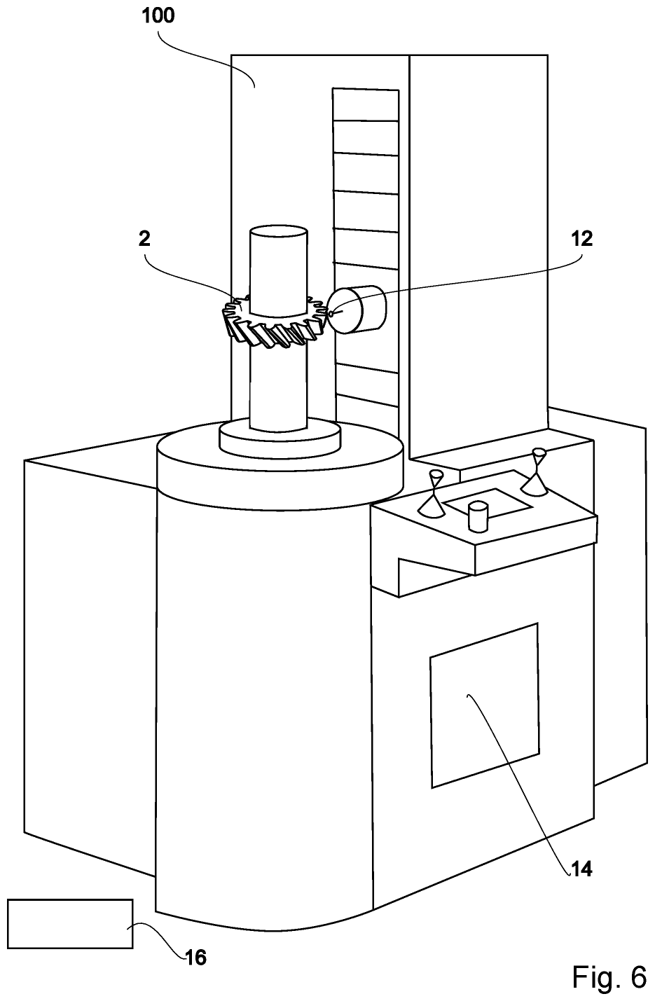

The measuring procedure is carried out by means of a coordinate measuring machine 100, wherein a measuring probe 12 scans the measuring grid 8 for one or more tooth flanks 4 or for each of the tooth flanks 4 in order to determine the actual position of the measuring points 10 of the measuring grid 8 for the measured tooth flanks 4 (FIG. 6).

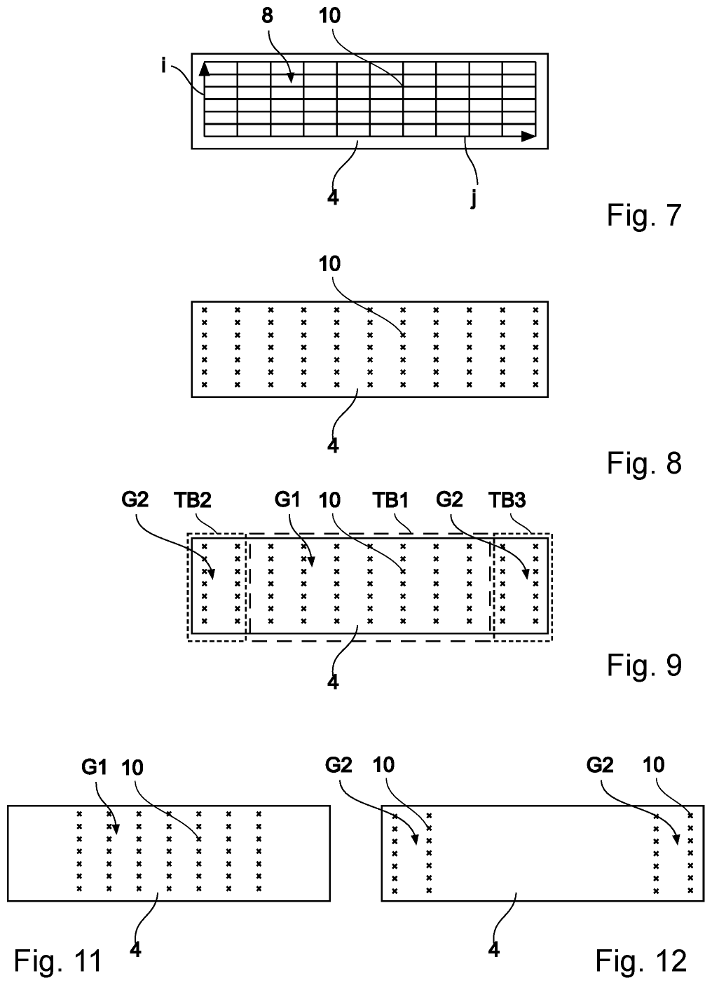

FIG. 7 schematically shows the measuring grid 8 for one of the tooth flanks 4, wherein the measuring grid 8 has seven rows i and eleven columns j, each represented by the grid lines. This results in 77 measuring points 10, which are shown in FIG. 8.

Then, in a method step (C), a deviation of the actual geometry of the measured tooth flanks 4 from a predetermined nominal geometry of the tooth flanks 4 is determined on the basis of the measuring points 10. The determination of the deviation can be computer-aided by means of a measuring computer 14 of the coordinate measuring machine or by means of an external computer 16 which is not part of the coordinate measuring machine.

In a method step (D), a corrected gear cutting process is determined for at least partial reduction of the deviation, with the determination of the corrected gear cutting process for at least partial reduction of the deviation having the specifications that a first permissible deviation of the actual geometry from the nominal geometry is specified for a first evaluation area AB1 of the tooth flank 4, that a second permissible deviation of the actual geometry from the nominal geometry is specified for a second evaluation area AB2 of the tooth flank 4, and that the first permissible deviation is smaller than the second permissible deviation. A first correction step or a first correction loop is therefore performed for the “gear hobbing” machining step of the gear cutting process.

The first evaluation area AB1 has a section TB1 of the tooth flank 4. The first evaluation area AB1 therefore corresponds to the first section TB1 (FIG. 9).

The second evaluation area AB2 has two sections of the tooth flank, namely a section TB2 and a section TB3. The second evaluation area therefore corresponds to the sections TB2 and TB3. The sections TB2 and TB3 are arranged at a distance from each other (FIG. 9).

All those measuring points 10 which are arranged within the first evaluation area AB1 form a first group G1 of measuring points 10 (FIG. 11). All those measuring points 10 that are arranged within the second evaluation area AB2 form a second group G2 of measuring points 10 (FIG. 12).

When determining the corrected gear cutting process by the first correction step for the “gear hobbing” machining step, narrower tolerances or smaller permissible deviations are therefore taken into account for the measuring points 10 of the first group G1 than for the second group G2 of measuring points 10. Furthermore, for a mathematical optimization for at least partial reduction of the deviation, a first weighting W1 is specified for a deviation of the first evaluation area AB1 of the tooth flank 4 and a second weighting W2 is specified for a deviation of the second evaluation area AB2 of the tooth flank 4, with the first weighting W1 being greater than the second weighting W2. In this case, the sum S of the weighted deviations is minimized during the optimization, with e.g. S=(W1*deviation AB1)+(W2*deviation AB2). It is understood that such a sum to be minimized can also be formed from weighted deviations of the individual measuring points of the evaluation areas or from weighted parameters or quality characteristics of the toothing, which have been calculated from the deviations of the individual measuring values or measuring points.

With the corrected gear hobbing process, deviations of the evaluation area AB1 are therefore corrected in a prioritized manner in order to produce the smallest possible deviations in the evaluation area AB1, while the deviations in the evaluation area AB2 are allowed to be larger compared to the evaluation area AB1.

The first permissible deviation may be associated with first tolerances for one or more of the subsequent toothing deviations and/or toothing modifications: Profile deviations, such as the profile total deviation, the profile shape deviation, the profile angle deviation, the meshing angle deviation or the like, and/or the deviations of one or more tooth flank modifications in the profile direction, such as deviations of the vertical crowning, the tip and/or root relief, the profile angle modification, the profile interleaving or the like; flank line deviations, such as the flank line total deviation, the flank line shape deviation, the flank line angle deviation, the spiral angle deviation or the like and/or the deviations of one or more tooth flank modifications in flank direction, such as deviations of the width crowning, the end relief, the flank line angle modification, the flank line interleaving or the like; pitch deviations, such as the pitch single deviation, the pitch sum deviation, the pitch jump or the like; tooth thickness deviations; concentricity deviations.

The second permissible deviation can be assigned second tolerances for one or more of the following toothing deviations and/or toothing modifications: Profile deviations, such as the profile total deviation, the profile shape deviation, the profile angle deviation, the meshing angle deviation or the like, and/or the deviations of one or more tooth flank modifications in the profile direction, such as deviations of the vertical crowning, the tip and/or root relief, the profile angle modification, the profile interleaving or the like; flank line deviations, such as the flank line total deviation, the flank line shape deviation, the flank line angle deviation, the spiral angle deviation or the like and/or the deviations of one or more tooth flank modifications in flank direction, such as deviations of width crowning, end relief, flank line angle modification, flank line interleaving or the like; pitch deviations, such as the pitch single deviation, the pitch sum deviation, the pitch jump or the like; tooth thickness deviations; concentricity deviations.

For example, it can be provided that a smaller tolerance for the flank line angle deviation can be specified for the first evaluation area AB1 than for the second evaluation area AB2. Further it can be provided, for example, that for the first evaluation area AB1 a smaller tolerance for the vertical crowning is preset than for the second evaluation area AB2. The first permissible deviation and the second permissible deviation therefore each have, in particular, several permissible tolerances for two or more parameters or quality characteristics of the toothing 2.

In machining step (E), another workpiece 2 is machined using the corrected gear cutting process, wherein the corrected gear cutting process has modified process kinematics for the “gear hobbing” machining step compared to the gear cutting process. Since the hobbing is a machining of the workpiece 2 with a non-dressable tool with a geometrically determined cutting edge, namely the hob 6, the possibility of changing the tool geometry is blocked and the possibility of changing the process kinematics is enabled before determining the corrected gear cutting process for the “gear hobbing” machining step.

After the further workpiece 2 has been manufactured with the corrected gear cutting process in the “gear hobbing” machining step, the workpiece geometry or the tooth flanks 4 can be checked again to determine any further need for correction or to check the effectiveness of the correction.

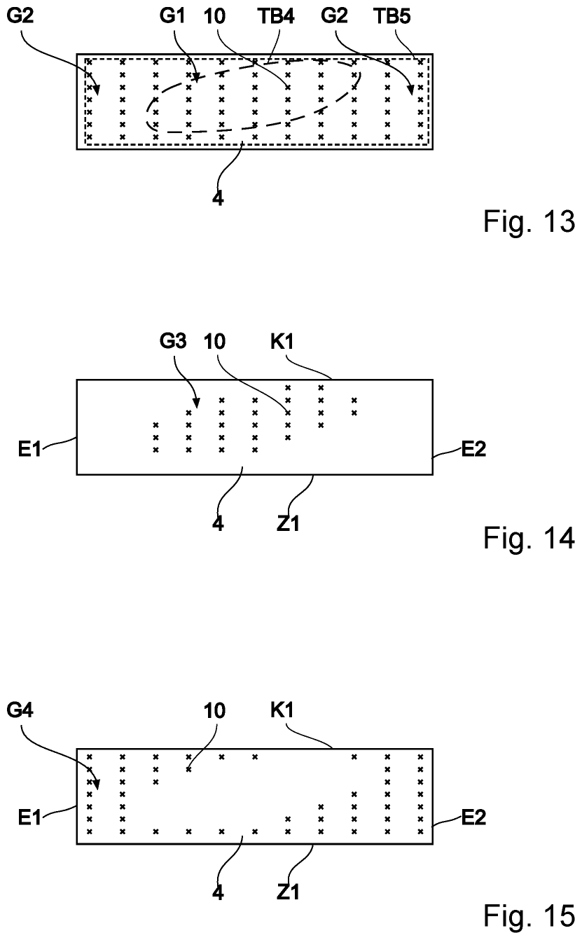

FIG. 13 shows another variant of a division of the tooth flank 4 into a first evaluation area AB1 and a second evaluation area AB2. A section TB4 is assigned to the first evaluation area AB1. In this case, the evaluation area AB1 includes the section TB4. This results in a group G3 of measuring points 10 of the first evaluation area, which is shown in FIG. 14. A section TB5 is assigned to the evaluation area AB2. The section TB5 has those areas of the tooth flank 4 which are located inside TB5 and outside TB4. In other words, section TB5 includes all areas of tooth flank 4 except section TB4. This results in a group G4 of measuring points 10 of the second evaluation area AB2 shown in FIG. 15.

The section TB4 corresponds to a load-bearing area of the tooth flank 4 that is at a distance from the tip edge K1, the tooth root Z1 and the ends E1, E2 of the tooth flank 4. In the present case, the section TB4 also corresponds to a section of the tooth flank 4 for which a predefined load threshold or a predefined load criterion is exceeded during operation.

In the present case, the section TB5 corresponds to an area of the tooth flank 4 that is adjacent to the tip edge K1, the tooth root Z1 and the ends E1, E2 of the tooth flank 4. In the present case, the section TB5 also corresponds to a section of the tooth flank 4 for which the load falls below a specified load threshold or a specified load criterion during operation.

For the first evaluation area AB1 of the tooth flank 4 according to FIG. 13, a first permissible deviation of the actual geometry from the nominal geometry is specified. For the second evaluation area AB2 of the tooth flank 4 according to FIG. 13, a second permissible deviation of the actual geometry from the nominal geometry is specified. The first permissible deviation is smaller than the second permissible deviation.

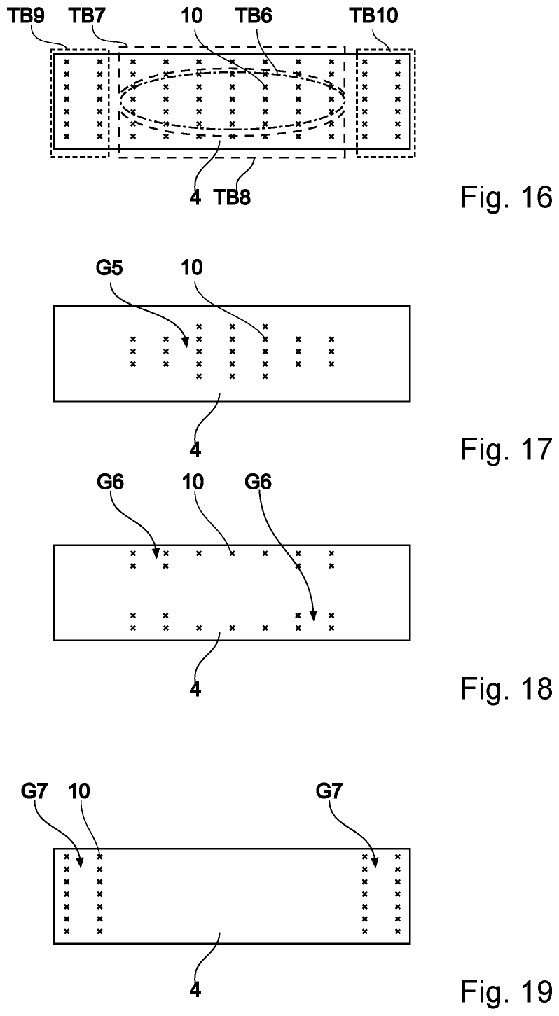

FIG. 16 shows another variant of a division of the tooth flank 4 into a first evaluation area AB1, a second evaluation area AB2 and a third evaluation area AB3. A section TB6 of the tooth flank 4 is assigned to the first evaluation area AB1. In this case, the evaluation area AB1 includes the section TB6. This results in a group G5 of measuring points 10 of the first evaluation area AB1, which is shown in FIG. 17. The second evaluation area AB2 is assigned the sections TB7 and TB8 as shown in FIG. 16. This results in a group G6 of measuring points 10 of the second evaluation area AB2, which is shown in FIG. 18. The third evaluation area AB1 is assigned the sections TB9 and TB10 as shown in FIG. 16. This results in a group G7 of measuring points 10 of the third evaluation area AB3, which is shown in FIG. 19.

For the first evaluation area AB1 of the tooth flank 4 according to FIG. 16, a first permissible deviation of the actual geometry from the nominal geometry is specified. For the second evaluation area AB2 of the tooth flank 4 according to FIG. 16, a second permissible deviation of the actual geometry from the nominal geometry is specified. For the third evaluation area AB3 of tooth flank 4 according to FIG. 16, a third permissible deviation of the actual geometry from the nominal geometry is specified. The first permissible deviation is smaller than the second permissible deviation. The second permissible deviation is smaller than the third permissible deviation. A corrected gear cutting process that has been adapted on the basis of the first, second and third permissible deviations makes it possible to maintain narrow tolerances for the first evaluation area, while permitting larger deviations for the second and third evaluation areas.

Therefore, the result of the first correction step is a corrected hobbing, which is a machining step of the corrected gear cutting process, and which allows maintaining different tolerances in prioritized areas of the tooth flanks 4.

In addition to the hobbing process described above, the gear cutting process can have one or more further machining steps which can be corrected by means of an associated correction step.

For example, it may be provided that the workpiece 2 is hardened after hobbing and then ground.

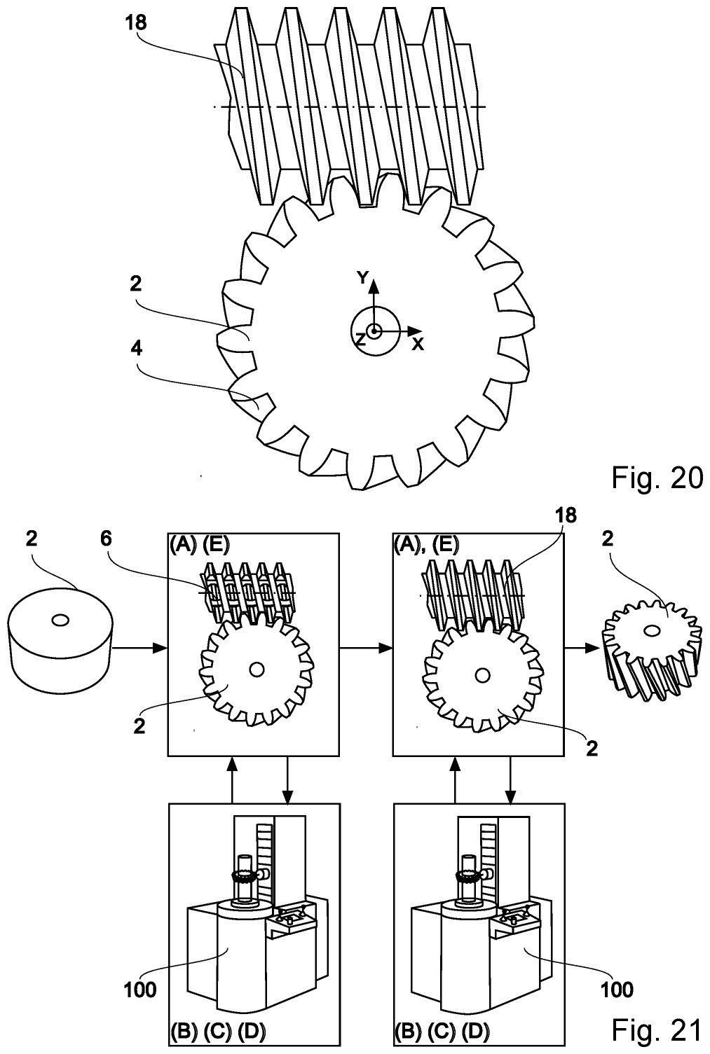

It can therefore be provided that the gear cutting process comprises the machining step “generating grinding”, so that in method step (A) a machining of previously hobbed tooth flanks 4 of the workpiece 2 is performed by means of a grinding tool 18 (FIG. 20). The generating grinding operation can be corrected in the same way as the hobbing operation described above in order to indicate a corrected generating grinding operation. A second correction step or correction loop is therefore associated with the generating grinding to indicate a corrected generating grinding as a machining step of the corrected gear cutting process.

FIG. 21 shows a possible process chain for the manufacture of gearwheels 2. The gear cutting process comprises the machining steps gear hobbing (A) and generating grinding (A). The gear hobbing (A) and generating grinding (A) machining steps can be corrected by the method according to the disclosure in a respective associated correction loop, so that after correction the gearwheels 2 are machined with a corrected gear hobbing (E) and/or a corrected generating grinding (E).

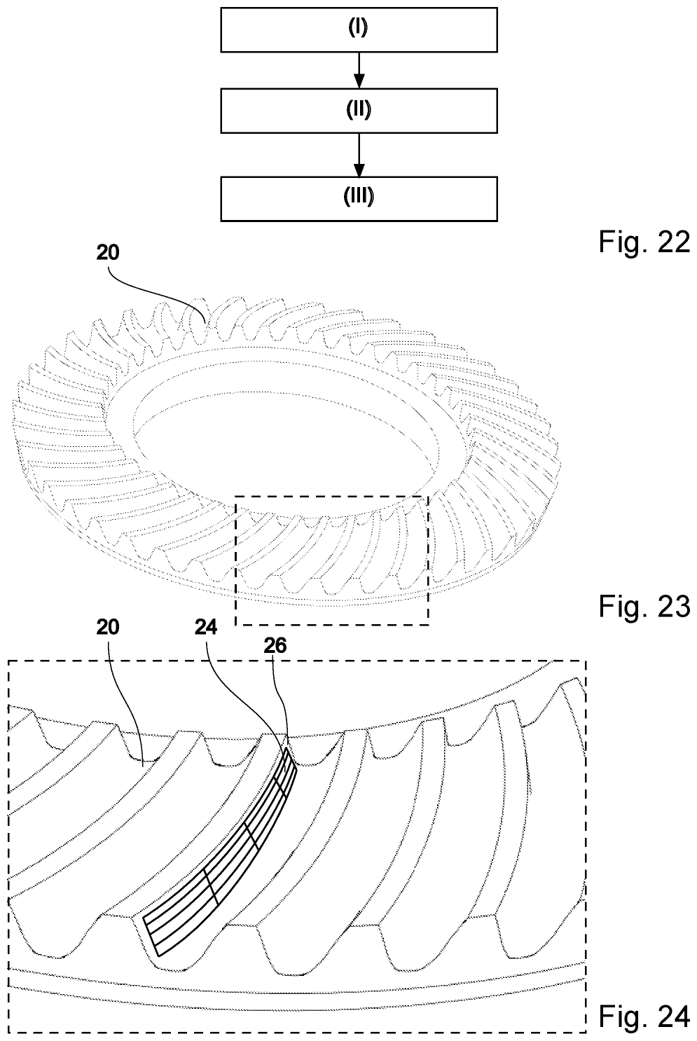

FIG. 22 shows a flow chart of a method according to the second aspect of the disclosure. In a first method step (I), an actual geometry of a tooth flank 4 of a workpiece 2 generated by means of a gear cutting process is measured by means of a measuring process. In a second method step (II), a deviation of the actual geometry of the tooth flank from a predetermined nominal geometry of the tooth flank is determined. In a third method step (III), the deviation is evaluated, with the evaluation of the deviation having the specification that a first permissible deviation of the actual geometry from the nominal geometry is specified for a first evaluation area of the tooth flank, that a second permissible deviation of the actual geometry from the nominal geometry is specified for a second evaluation area of the tooth flank, and that the first permissible deviation is smaller than the second permissible deviation.

The first evaluation area and the second evaluation area as well as the permissible deviations correspond to those evaluation areas and deviations which have already been described for the first aspect of the disclosure. All variants and embodiments of the evaluation areas and the permissible deviations that have been described for the first aspect of the disclosure therefore also apply to the second aspect of the disclosure and can be transferred in an identical manner to the second aspect of the disclosure.

FIG. 23 shows a bevel gear 20 as a workpiece 20, with FIG. 24 showing a cutaway enlargement of the bevel gear 20 of FIG. 23.

The bevel gear 20 can be machined and measured analogously to the spur gear described above or the example described below. A measuring grid 24 is shown for a tooth 22 of the bevel gear, to which evaluation areas and sections of a tooth flank 26 with a corresponding permissible deviation and weightings can be assigned analogously to FIGS. 7-19.

It can be provided that during machining of the workpiece 20 by means of the gear cutting process all tooth flanks 26 of the workpiece 20 are machined, wherein during measuring of the actual geometry generated by means of the gear cutting process two or more tooth flanks 26 of the workpiece 20 are measured by means of the measuring method; wherein, when determining deviations of the actual geometry of the respectively measured tooth flanks 26 from the predetermined nominal geometry, a mean deviation is determined from the deviations of the respectively measured tooth flanks 26; and wherein, when determining the corrected gear cutting process for at least partial reduction of the deviations, the mean deviation is used and applies to all tooth flanks 26.

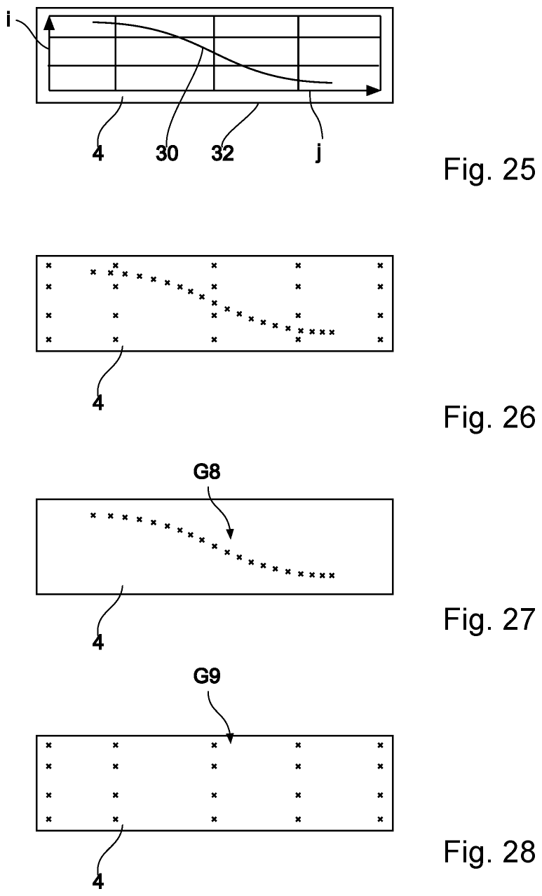

FIGS. 25-28 show exemplarily for a tooth flank 4 that evaluation areas AB1 and AB2 can overlap each other. The first evaluation area AB1 has a group G8 of measuring points 10, which are shown in FIG. 27 and which have been scanned along a contact path 30 of the tooth flank 4. The second evaluation area AB2 has a group G9 of measuring points 10 which have been defined by the measuring grid 32, wherein the grid lines i, j, have also been scanned to determine the measuring points 10 according to FIG. 28.

None of the measuring points 10 assigned to the first evaluation area AB1 (FIG. 27) is assigned to the second evaluation area AB2 (FIG. 28).

The contact path 30 has been scanned with a higher resolution than the grid lines i, j of the measuring grid 32.

1. A method for machining and measuring workpieces, the method includes the following steps:
machining a workpiece by a gear cutting process, wherein a tooth flank of the workpiece is produced or machined,
measuring an actual geometry of the tooth flank of the workpiece generated by the gear cutting process using a measuring method,
determining a deviation of the actual geometry of the tooth flank from a specified nominal geometry of the tooth flank,
determining a corrected gear cutting process to at least partially reduce the deviation, and
machining the workpiece and/or another workpiece by the corrected gear cutting process,
wherein
the determination of the corrected gear cutting process for at least partial reduction of the deviation has the specification that a distinction is made between a first evaluation area of the tooth flank and a second evaluation area of the tooth flank,
wherein a first permissible deviation of the actual geometry from the nominal geometry is predetermined for the first evaluation area of the tooth flank, a second permissible deviation of the actual geometry from the nominal geometry is predetermined for the second evaluation area of the tooth flank, and the first permissible deviation is smaller than the second permissible deviation,
and/or
wherein for mathematical optimization for at least partial reduction of the deviation, a first weighting is specified for a deviation of the first evaluation area of the tooth flank and a second weighting is specified for a deviation of the second evaluation area of the tooth flank, wherein the first weighting is greater than the second weighting.

2. The method according to claim 1,
wherein the first evaluation area has one or more sections of the tooth flank, which are arranged contiguously and/or at least in regions spaced apart from one another, and/or
the second evaluation area has one or more sections of the tooth flank, which are arranged contiguously and/or at least in regions spaced apart from one another.

3. The method according to claim 1,
wherein the first evaluation area is assigned a load-bearing area of the tooth flank which is at a distance from ends or edges of the tooth flank and/or
the second evaluation area is assigned an edge region which has ends or edges of the tooth flank or is adjacent thereto.

4. The method according to claim 1,
wherein the first evaluation area is assigned one or more sections of the tooth flank which, in operation, have a contact with a mating flank; and/or
the first evaluation area is assigned one or more sections of the tooth flank for which a predetermined load threshold or a predetermined load criterion is exceeded during operation;
and/or
the second evaluation area is assigned one or more sections of the tooth flank which have no contact with a mating flank during operation; and/or
the second evaluation area is assigned one or more sections of the tooth flank for which the load falls below a predetermined load threshold or a predetermined load criterion during operation.

5. The method according to claim 1,
wherein when the actual geometry of the tooth flank of the workpiece generated by the gear cutting process is measured by the measuring process, a measuring grid with measuring points is detected,
when determining the deviation of the actual geometry of the tooth flank from the predetermined nominal geometry of the tooth flank, a respective deviation of the actual position of the respective measuring point from the nominal position of the respective measuring point is determined for each measuring point of the measuring grid, and
a first group of the measuring points is assigned to the first evaluation area, and a second group of the measuring points is assigned to the second evaluation area.

6. The method according to claim 1,
wherein, after machining of the workpiece and/or of a further workpiece by the corrected gear cutting process, an actual deviation of a tooth flank machined by the corrected gear cutting process is smaller for the first evaluation area than the first permissible deviation and is smaller for the second evaluation area than the second permissible deviation.

7. The method according to claim 1,
wherein two or more tooth flanks of the workpiece are produced or machined during machining of the workpiece by the gear cutting process,
when measuring the actual geometry generated by the gear cutting process, two or more tooth flanks of the workpiece are measured by the measuring method;
when determining deviations of the actual geometry of the respectively measured tooth flanks from the predetermined nominal geometry, an average deviation is determined from the deviations of the respectively measured tooth flanks; and
the corrected gear cutting process for at least partial reduction of the deviations is determined on the basis of the mean deviation and applies to all tooth flanks.

8. The method according to claim 1,
wherein the corrected gear cutting process has modified process kinematics compared to the gear cutting process,
and/or
the corrected gear cutting process has a modified tool geometry compared to the gear cutting process.

9. The method according to claim 1,
wherein before determining the corrected gear cutting process, the possibility of changing the tool geometry is enabled or disabled; and/or
before determining the corrected gear cutting process, the possibility of changing the process kinematics is enabled or disabled.

10. The method according to claim 1,
wherein the determination of the corrected gear cutting process is performed by a nonlinear optimization.

11. The method according to claim 1,
wherein the first permissible deviation is assigned first tolerances for one or more of the subsequent toothing deviations:
profile deviations, such as the total profile deviation, the profile shape deviation, the profile angle deviation, the pressure angle deviation, and/or the deviations of one or more tooth flank modifications in the profile direction, such as deviations of the vertical crowning, the tip and/or root relief, the profile angle modification, the profile interleaving;
flank line deviations, such as the flank line total deviation, the flank line shape deviation, the flank line angle deviation, the spiral angle deviation and/or the deviations of one or more tooth flank modifications in flank direction, such as deviations of width crowning, end reliefs, flank line angle modification, flank line interleaving;
pitch deviations, such as the pitch single deviation, the pitch sum deviation, the pitch jump;
tooth thickness deviations;
concentricity deviations;
roundness deviations;
runout deviations;
Flatness deviations;
warping/interleaving;
and/or
the second permissible deviation is assigned second tolerances for one or more of the subsequent toothing deviations:
profile deviations, such as the total profile deviation, the profile shape deviation, the profile angle deviation, the pressure angle deviation, and/or the deviations of one or more tooth flank modifications in the profile direction, such as deviations of the vertical crowning, the tip and/or root relief, the profile angle modification, the profile interleaving;
flank line deviations, such as the flank line total deviation, the flank line shape deviation, the flank line angle deviation, the spiral angle deviation and/or the deviations of one or more tooth flank modifications in flank direction, such as deviations of width crowning, end reliefs, flank line angle modification, flank line interleaving;
pitch deviations, such as the pitch single deviation, the pitch sum deviation, the pitch jump;
tooth thickness deviations;
concentricity deviations;
roundness deviations;
runout deviations;
flatness deviations;
warping/interleaving;
wherein the first tolerances at least partially deviate from or are identical to the second tolerances and/or wherein the toothing deviations associated with the first permissible deviation at least partially deviate from or are identical to the toothing deviations associated with the second permissible deviation.

12. The method according to claim 1, wherein
the first permissible deviation of the actual geometry from the nominal geometry for a respective measuring point or a section of the first evaluation area is selected from a range less than or equal to 10 μm, in particular selected from a range less than or equal to 5 μm, and
the second permissible deviation of the actual geometry from the nominal geometry for a respective measuring point or a section of the second evaluation area is selected from a range smaller than or equal to 15 μm, in particular selected from a range smaller than or equal to 10 μm.

13. The method according to claim 1, wherein
the gear cutting process comprises one or more of the following method steps:
machining the workpiece with a tool having a geometrically defined cutting edge, such as gear hobbing, profile milling, gear shaping, hob peeling, bevel gear milling;
machining the workpiece with a tool having a geometrically indeterminate cutting edge, such as grinding, lapping, honing;
pre-cutting in the soft state of the workpiece;
hard machining of the workpiece in the hard state after hardening of the workpiece.

14. The method according to claim 1, wherein
workpiece is a gearwheel of a toothed gearing, such as a spur gear, a bevel gear,
wherein a plurality of tooth flanks of the gearwheel are machined or produced during machining of the gear by the gear cutting process.

15. A method for machining and measuring workpieces, the method including the following steps:
measuring an actual geometry of a tooth flank of a workpiece generated by a gear cutting process,
determining a deviation of the actual geometry of the tooth flank from a specified nominal geometry of the tooth flank, and
evaluating the deviation,
wherein
the evaluation of the deviation has the specification
that a first permissible deviation of the actual geometry from the nominal geometry is specified for a first evaluation area of the tooth flank,
that a second permissible deviation of the actual geometry from the nominal geometry is specified for a second evaluation area of the tooth flank, and
that the first permissible deviation is smaller than the second permissible deviation.

16. The method according to claim 15,
wherein the first evaluation area is assigned a tooth flank load-bearing area which is at a distance from ends or edges of the tooth flank and/or
the second evaluation area is assigned an edge region which has ends or edges of the tooth flank or is adjacent thereto.

17. The method according to claim 15,
wherein when the actual geometry of the tooth flank of the workpiece generated by the gear cutting process is measured by the measuring process, a measuring grid with measuring points is detected,
when determining the deviation of the actual geometry of the tooth flank from the predetermined nominal geometry of the tooth flank, a deviation of the actual position of the respective measuring point from the nominal position of the respective measuring point is determined for each measuring point of the measuring grid, and
a first group of the measuring points is assigned to the first evaluation area and second group of the measuring points is assigned to the second evaluation area.
